(19) United States
(12) Patent Application Publication
(10) Pub. No.: US 2006/0024222 A1
(43) Pub. Date: Feb. 2, 2006

(54) Method and apparatus for carrying out exothermic gas phase reactions

(76) Inventors: Josef Dachs, Deggendorf (DE); Wolfgang Schuster, Moos (DE); Rolf Bank, Deggendorf (DE); Manfred Lehr, Deggendorf (DE)

Correspondence Address: MILDE & HOFFBERG, LLP, 10 BANK STREET, SUITE 460, WHITE PLAINS, NY, 10606, US

(21) Appl. No.: 11/193,972

(22) Filed: Jul. 29, 2005

(30) Foreign Application Priority Data
Jul. 30, 2004 (DE) 10 2004 037 154.7

(51) Int. Cl. F28D 7/00; C01B 15/013

(52) U.S. Cl. 422/201; 23/293 R

(57) ABSTRACT

With a method for operating a tube bundle reactor for exothermic gas phase reactions having a tube bundle with catalyst-filled reaction tubes (2), wherein the one ends of the reaction tubes are spanned by a gas inlet hood and the other ends are spanned by a gas outlet hood and wherein around the outside of the reaction tubes a heat transfer medium flows to carry off reaction heat. An explosive gas mixture (G) is introduced into the reaction tubes (2) via the gas inlet hood and after reaction the gas mixture (G), that may still be explosive, it is led off from the reaction tubes via the gas outlet hood. A limit temperature in the reaction tubes (2) is specified that lies above the normal operating temperatures in the reaction tubes (2) but at most equals the ignition temperature of the explosive gas mixture (G) Each non-operating high temperature region (7) forming in the reaction tubes (2) whose temperature is at least equal to the limit temperature and which migrates in the respective reaction tube (2) in the longitudinal direction thereof is stopped while still in the reaction tube (2) so that the high temperature region (7) is prevented from advancing into the gas inlet hood or the gas outlet hood.

The invention relates to a method to operate a tube bundle reactor for exothermic gas phase reactions, having a bundle of tubes with reaction tubes filled with catalysts one end of which is spanned by a gas inlet hood and the other one by a gas outlet hood and around the outside of which a heat transfer medium flows to carry off the reaction heat, comprising the following steps: An explosive gas mixture is introduced into the reaction tubes through the gas inlet hood and after reaction the possibly still explosive gas mixture is led off from the tubes via the gas outlet hood. The invention also relates to devices and reaction tubes for such tube bundle reactors and to the latter themselves.

Such tube bundle reactors are already known from U.S. Pat. No. 3,850,232 or WO 2004/052524 A1. The reaction tubes generally run vertically and essentially contain a particle shaped catalyst through which the reaction gas mixture flows. This stationary positioning of the catalyst in the reaction tube bundle is referred to as a fixed bed. The reaction heat generated with exothermic gas phase reactions must be carried off by means of a heat exchange. This heat exchange occurs, on the one hand, inside the fixed bed in the process gas mixture that is reacting in the fixed bed itself and, secondly, between the fixed bed and a separate heat transfer medium. For this the reaction tubes are attached between two tube sheets in which the ends of the reaction tubes are fastened along their outside periphery so that gas cannot leak out, and the heat transfer medium flows around the tube bundle that is surrounded by a reactor shell. The heat transfer medium is mostly distributed evenly by shell windows via ring channels over the periphery of the shell space or tube bundle.

The direction of flow of the reaction gas mixture and the heat transfer medium is not restricted. In that way the reaction gas and the heat transfer medium can be led downwards or upwards through the tube bundle reactor, more specifically either both in the same direction of flow (i.e. in co-current) or in opposite directions of flow (i.e. in counter-current), or in a combination of them if several ring channels are provided. The heat transfer medium, frequently a salt bath, is circulated by means of a circulation pump and heated or cooled by the heat exchange, depending on the type of reaction process.

With exothermic gas phase reactions frequently one or more regions of increased temperature are formed in the reactor tubes that are referred to as a “hot spot”. On such hot spots the chemical reaction proceeds particularly violently and increased reaction heat is accordingly generated.

For commercial reasons an attempt is made, on the other hand, to introduce the highest possible concentration of reactants in the reaction gas mixture for the reaction sought, something that can have the effect that its composition exceeds the lower explosion limit or drops below the upper explosion limit and an explosive gas mixture is fed to the reaction tubes. Since the desired reactions mostly convert the reactants only partially, the exiting gas mixture is frequently also still capable of exploding.

Under such operating conditions, in practice explosions can repeatedly be observed in the gas spaces adjacent to the reaction tubes; that is, in the gas input and/or gas output hoods. From there, the explosion or the resulting flame front can propagate into the connecting pipes. In the general view of those skilled in the art, such explosions are triggered by sources of ignition located in the gas spaces.

Numerous devices for suppressing the propagation of free flames in the gas spaces or pipes, so-called “flame arresters”, are known.

Such devices include static-dry flame arresters such as those described in DE 101 12 957 or EP 0 649 327. These are elements where the effect is taken advantage of that flames in narrow spaces or gaps can no longer expand if suitable limiting dimensions are met and are thus brought to extinction. This normally occurs through the flames' intense contact with cooling walls, e.g. by leading the flame through narrow gaps. Such flame arresters can be made as closed-mesh sieves, plate safety devices, sintered metals, pellet beds or strap safety devices made of profiled rolled up straps. These known flame arresters with narrow spaces can extinguish a fast flame or an explosion wall in only a short period of time by carrying off heat with a large heat transfer surface.

Moreover, flame arresters such as those in DE 198 37 146, EP 0 131 782, DE 295 11 991, DE 296 06 948 or DE 199 12 326 are known where the melting of a solder triggers a lock or shut-off unit under spring tension. Such flame arresters are generally completed as finished modules with screw and flange connections and as a rule are interposed in individual pipes serving the transport of gas. In the event of inadmissible heat-up of the pipes, such as can arise from fire inside or outside of the pipes, these flame arresters are supposed to suppress the flow of gas through the pipes. Such flame arresters are used, as an example, in safety fixtures of gas supply plants.

A disadvantage with all of these known flame arresters is that their having an effect puts the tube bundle reactor completely out of operation. Such down times and the re-starting of the reactor entail considerable costs. In addition, the explosions can endanger persons and adjacent objects can be damaged.

Accordingly, the object of the invention is to prevent as far as possible ignitions of explosive gas mixtures in a tube bundle reactor for exothermic gas phase reactions or to reduce their frequency.

The invention achieves this object with a method of the type described above by means of the following steps: a limit temperature in the reaction tubes is specified that lies above the normal operating temperatures of the reaction tubes but is at most equal to the ignition temperature of the explosive gas mixture; and each non-operating high temperature region forming in the reaction tubes whose temperature is at least equal to the limit temperature and that migrates in the respective reaction tube in the longitudinal direction thereof is stopped in the reaction tube so as to prevent the high temperature region from advancing into the gas inlet or gas outlet hood.

According to the invention the problem can also be solved by means of a device according to claim 10 as well as with reaction tubes according to claims 32 and 34 as well as by means of a tube bundle reactor in accordance with claim 35.

Claim 36 indicates application options for an inventive tube bundle reactor.

The sub-claims indicate particular advantageous embodiment options.

The invention is based on the insight that, contrary to the view prevalent in the art, according to which in particular with a maleic anhydride reactor ignition originating from the reactor tubes is considered to be highly unlikely, under certain conditions a non-operating high temperature region or hot spot in the reaction tubes can migrate to the boundaries of the fixed bed filling and then becomes the source of ignition for the adjacent gas spaces there. The applicant has in recent experiments surprisingly discovered this. In this context it was observed that the hot spot can migrate both in counter-current to the reaction gas's direction of flow towards the gas inlet hood as well as in the direction of flow towards the gas outlet hood. Moreover, it was observed that this effect only appears upwards of a specific concentration of reactants and depending on operating conditions and becomes all the more pronounced with an additionally increasing concentration.

The expression “non-operating” is supposed to make it clear that the high temperature regions are only formed by accident and only in individual reaction tubes and are not part of the programmed operation of a tube bundle reactor.

The conditions necessary for a hot spot to migrate do not as a rule correspond to the regular reaction conditions in a tube bundle reactor. In reactors with a large number of reaction tubes (modern tube bundle reactors can have up to 30,000 reaction tubes and more) however it can occur that in individual reaction tubes non-optimum reaction conditions prevail. Possible causes for this are, for instance, local catalyst over-activity, partially clogged reaction tubes due to catalyst dust or foreign particles, resulting in reduced through-put, locally heightened concentrations due to inadequate gas mixture preparation or locally heightened heat transfer medium temperatures. Any one of these effects, or a combination of them, can entail the reaction in individual reaction tubes getting out of control, whereby the temperature in the respective reaction tube rises sharply at the hot spot and this hot spot begins to migrate. If the hot spot reaches the beginning or the end of the fixed bed filling in the reaction tube there is the danger that the hotspot will ignite the adjacent explosive gas mixture and cause it to explode.

The ignition temperature does not correspond to the theoretical ignition temperature of a gas or gas mixture at rest but relates to the flowing gas mixture in the gas inlet or gas outlet hoods.

This effect is all the more crucial the closer the gas mixture is to its stoichiometric composition. Examples of processes that, as is well known, are operated at least to some extent in the explosion range and that can thus be critical for the effect described above, would be production of maleic anhydride, phthalic anhydride, (meth)acrolein, (meth)acrylic acid, methyl-(meth)acrylate and acrylonitrile as well as ethanoic acid.

With the inventive measures non-operational migration of a high temperature region of a strongly exothermic gas phase reaction inside the reaction tube is suppressed before it gets to an explosive gas mixture and ignites. Thus, an explosion of the gas mixture in the gas inlet and/or outlet hood is prevented by having a potential source of ignition in a reaction tube (or in several reaction tubes) neutralised inside the reaction tube in question at a sufficient distance to the explosive gas mixture. In this way, at most, the reaction tube in question is put out of operation but not the entire tube bundle reactor. This thus enhances the safety of persons and property and simultaneously increases the availability of the production plant, in particular with high concentrations of reactants. The inventive measures can be achieved with relatively minor technical effort and thus prevent ignition of an explosive gas mixture in the gas inlet hood or the gas outlet hood of a tube bundle reactor for exothermic gas phase reactions in an extremely economical way.

The flame arresters known from the state of the art and described above are neither designed nor suitable for the inventive measures.

A high temperature region migrating in a reaction tube in its longitudinal direction is not a free flame but a heated place (hot spot) in the particle filling. The migration of the high temperature region in a reaction tube along the tube axis occurs substantially slower when compared with the expansion speed of a flame front. The static-dry flame arresters described above and known from the state of the art in which the flames are brought to extinction in narrow spaces would be continually heated up by the slowly migrating high temperature region and would no longer be able to accomplish the function of absorbing the reaction heat. Therefore the high temperature region would pass through such flame arresters.

The other known devices, likewise described above, having a lock under spring tension, are not designed for installation in the inside of a tube, but for in-line arrangement between two tube ends. In addition, with known devices inserted directly into the filling, the particles would obstruct the closing movement. On the other hand, installation of such known devices in a particle-free space in the filling cannot adequately ensure that there will be no propagation of the high temperature region since in that case the reaction periods are too long.

All inventive devices are constructed relatively simply, function reliably and are quickly mounted and therefore very economical. They have been designed to be inserted into the reaction tubes, in which case they are completely or partially embedded there in the catalyst filing or border on the latter. The reaction tubes can where applicable also be partially filled with inert particles. To stop the high temperature region, inventive devices have a through-flow section, the size of which is determined as a function of the specified limit temperature and in the preferred embodiments is reducible to zero when the limit temperature is reached so that the reaction tube in question is then closed off. By reducing the through-flow section the velocity of flow is increased and further movement of the high temperature region is suppressed by way of “blowing it back.” By closing off the reaction tube containing a high temperature region, through-flow of the reaction tube in question is completely suppressed and in that way the, high temperature region is extinguished.

In an alternative embodiment of the invention, for stopping the high temperature region, the reaction conditions in the reaction tube in question are modified when the limit temperature is reached in order to extinguish the high temperature region. For instance, for this the reaction tubes may be filled with a filling containing fluid and/or solid matter that evaporate when the limit temperature is reached and inert and/or additionally cool the gas flow.

The invention is explained in greater detail here below with reference to the accompanying drawings, in which:

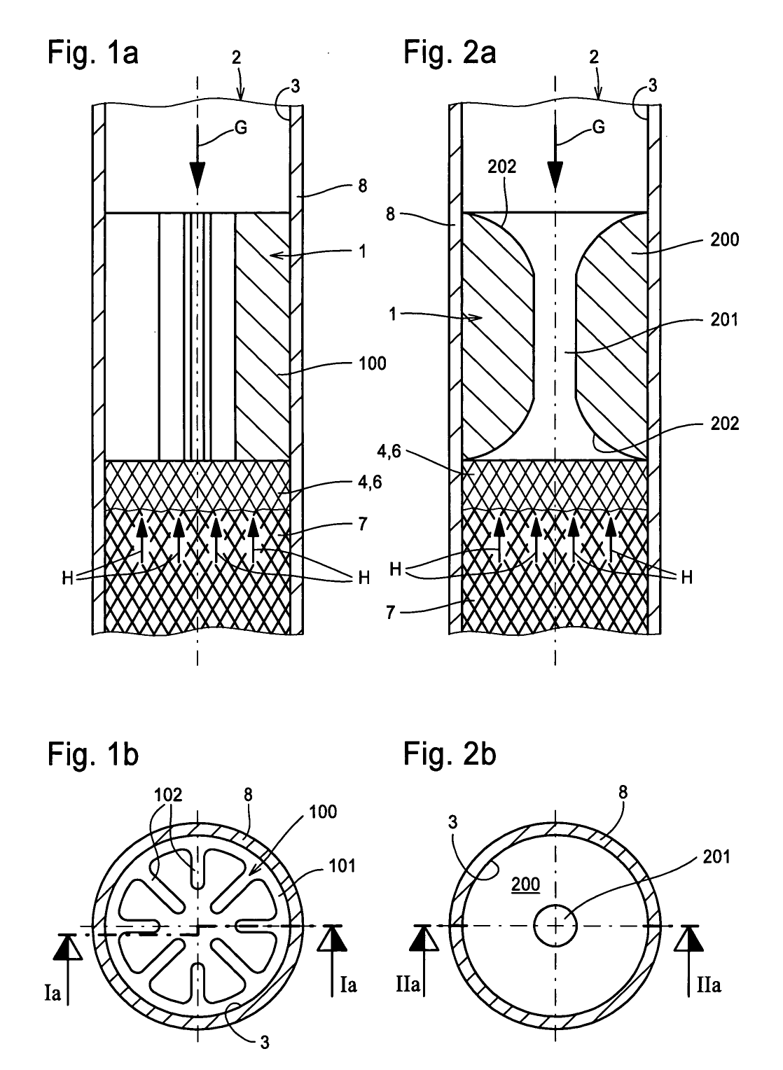

FIG. 1a is a longitudinal section through a first embodiment of a device according to the invention, installed in a reaction tube, taken along the line Ia-Ia in FIG. 1b;

FIG. 1b is a top view of the embodiment in FIG. 1a;

FIG. 2a is a longitudinal section through a second embodiment of a device according to the invention, installed in a reaction tube, taken along the line IIa-IIa in FIG. 2b;

FIG. 2b is a top view of the embodiment in FIG. 2b;

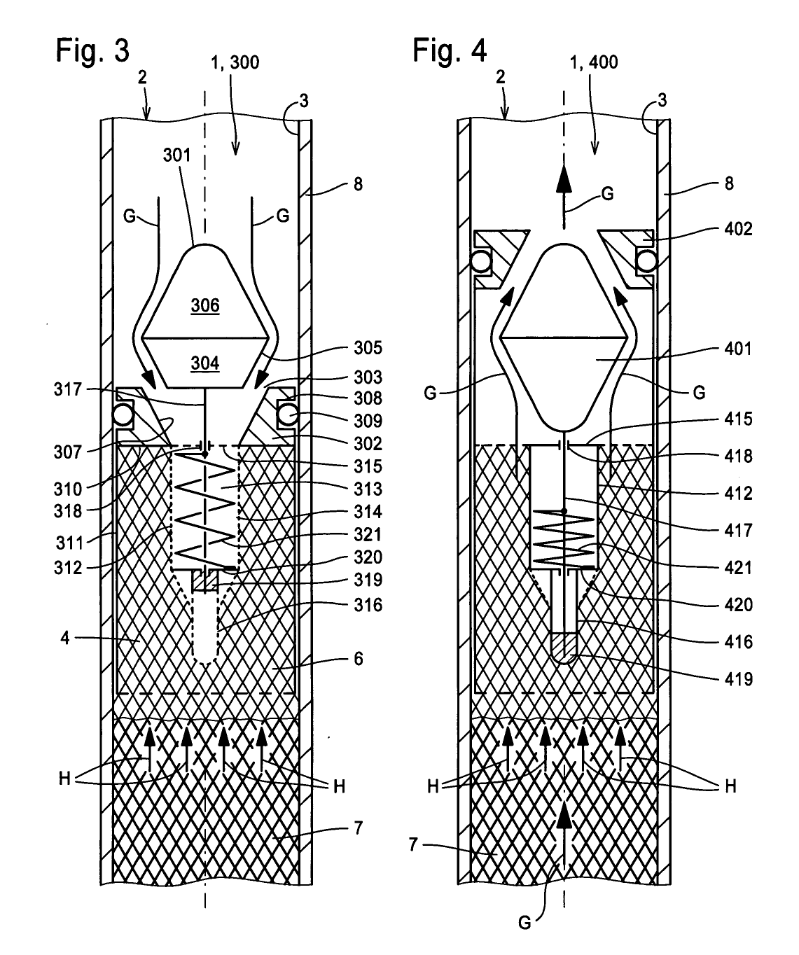

FIG. 3 is a longitudinal section through a third embodiment of a device according to the invention, installed in a reaction tube;

FIG. 4 is a longitudinal section through a fourth embodiment of a device according to the invention, installed in a reaction tube;

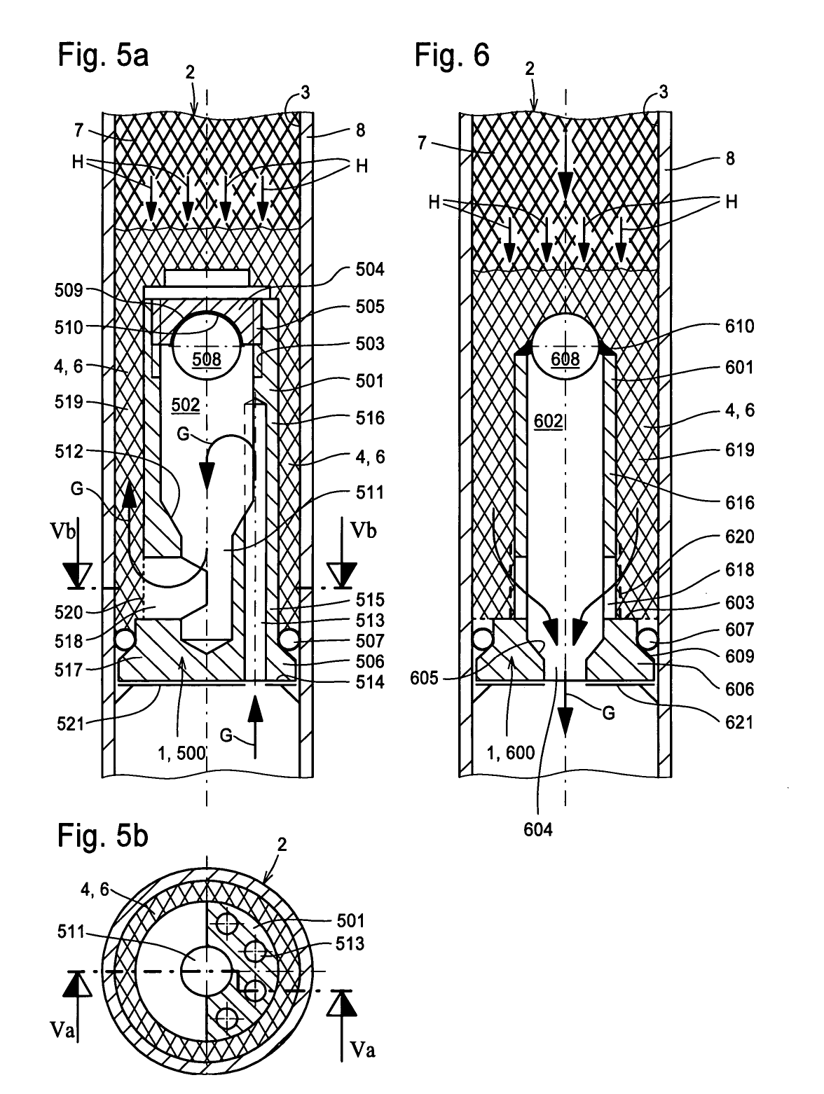

FIG. 5a is a longitudinal section through a fifth embodiment of a device according to the invention, installed in a reaction tube, taken along the line Va-Va in FIG. 5b;

FIG. 5b is a top view of the embodiment in FIG. 5a along the line Vb-Vb in FIG. 5a;

FIG. 6 is a longitudinal section through a sixth embodiment of a device according to the invention, installed in a reaction tube;

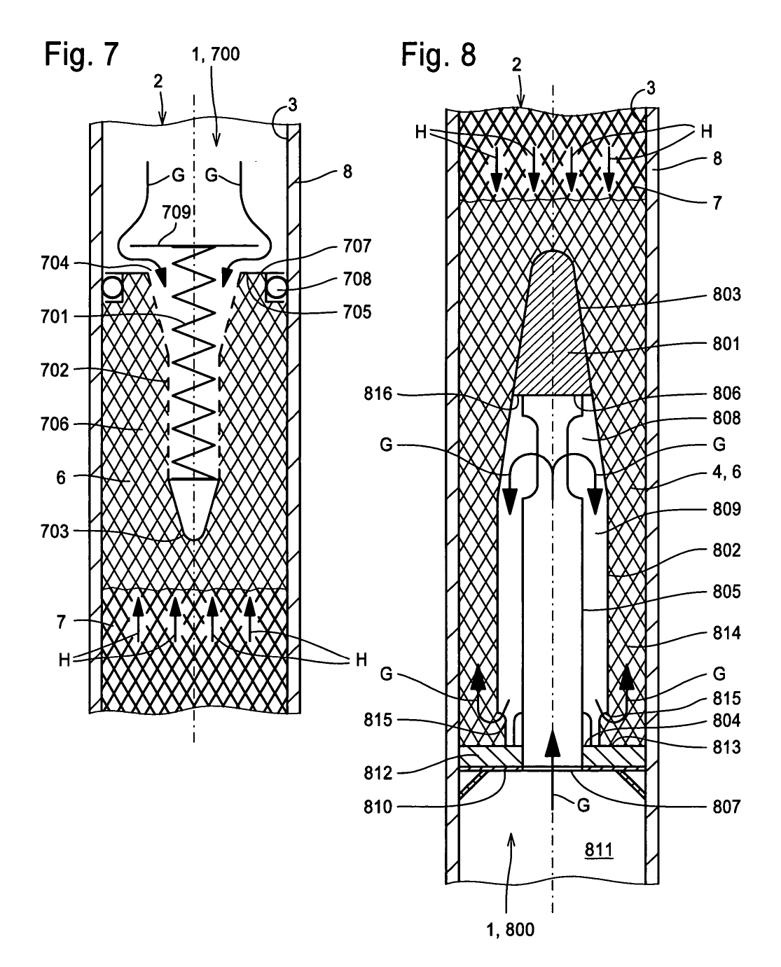

FIG. 7 is a longitudinal section through a seventh embodiment of a device according to the invention, installed in a reaction tube;

FIG. 8 is a longitudinal section through an eighth embodiment of a device according to the invention, installed in a reaction tube;

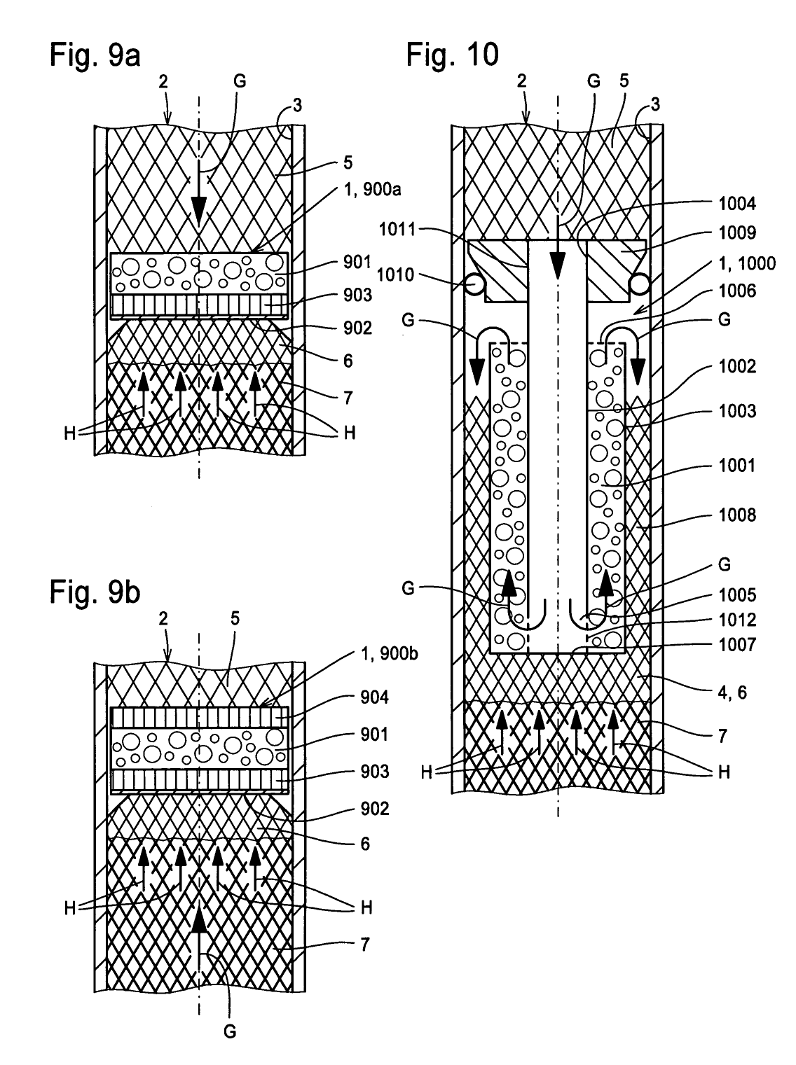

FIG. 9a is a longitudinal section through a ninth embodiment of a device according to the invention, installed in a reaction tube where the reaction gas mixture flows from top to bottom;

FIG. 9b is a longitudinal section through a modification of the ninth embodiment from FIG. 9a installed in a reaction tube where the reaction gas mixture flows from bottom to top;

FIG. 10 is a longitudinal section through a tenth embodiment of a device according to the invention, installed in a reaction tube;

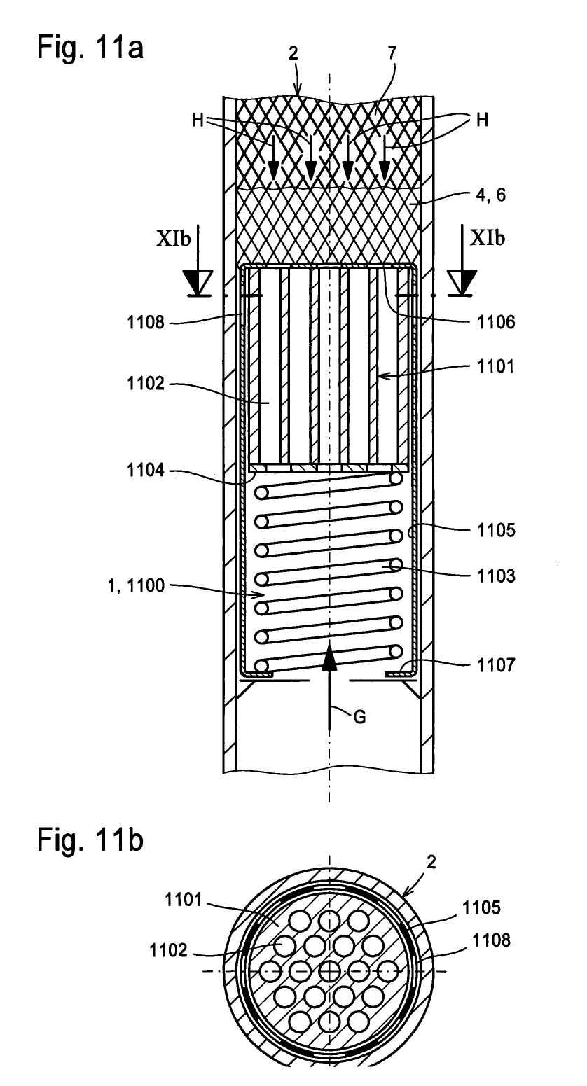

FIG. 11a is a longitudinal section through an eleventh embodiment of a device according to the invention, installed in a reaction tube;

FIG. 11b is a cross-section along the line XIb-XIb in FIG. 11a;

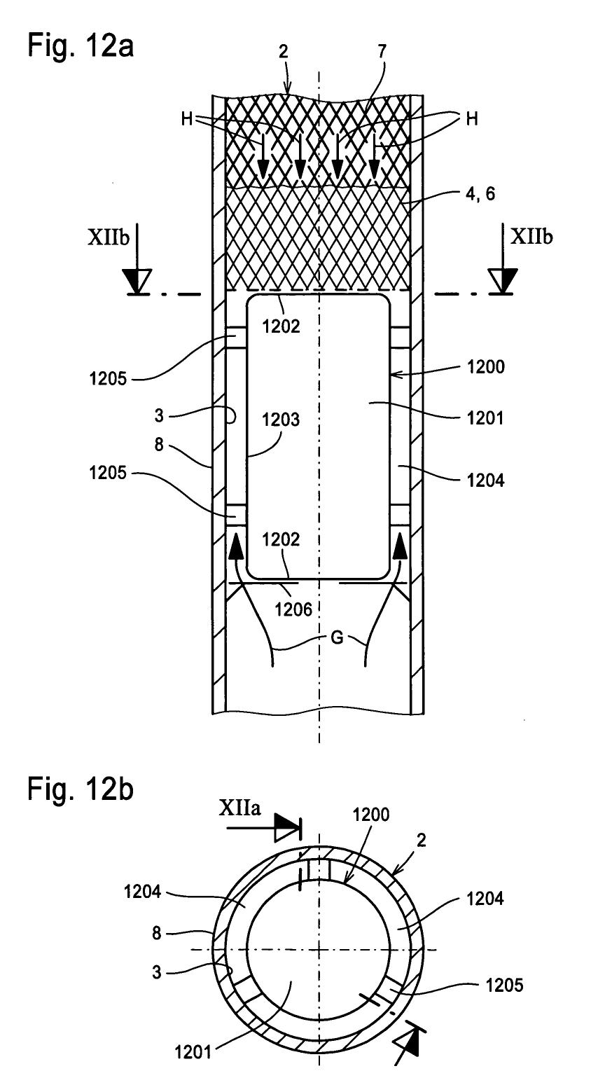

FIG. 12a is a longitudinal section through a twelfth embodiment of a device according to the invention, with an internal displacer and installed in a reaction tube, taken along the line XIIa-XIIa in FIG. 12b; and

FIG. 12b is a cross-section along the line XIIb-XIIb in FIG. 12a.

The embodiments of inventive devices 1, shown in the figures, are in each case shown in their state of being inserted into a reaction tube 2.

The reaction tubes 2 are filled with catalyst particles 4 or, where applicable, partially with inert particles 5. This filling is referred to as the filling or bed 6.

A high temperature region 7 that formed in the filling 6 is depicted in the figures in bold hatching. This high temperature region 7 migrates in the direction of the four arrows H towards an inventive device 1. The direction of flow of the gas mixture G is shown with arrow G.

In FIGS. 1a, 1b, 2a, 2b, 12a and 12b embodiments 100, 200, 1200 of inventive devices 1 are depicted that reduce the through-flow cross-section, and thus raise the through-flow velocity of the gas mixture G, to the point that further migration of the high temperature region 7 through the device or the insert is prevented; the high temperature region or the hot spot 7 is thus, so to speak, “blown back” into the reaction tube 2 and in that way brought to a standstill.

Such embodiments 100, 200, 1200 are suitable for preventing a hot spot 7 migrating counter to the direction of flow of the reaction gas mixture G from moving further. Installation can also be made in the lower part of the reaction tube 2 as well.

The exterior shape of inserts 100, 200, 1200 is adapted to the hollow section of the reaction tubes 2. With cylindrical reaction tubes (as in the embodiment examples shown) the inserts are likewise cylindrical.

The embodiment 100 according to FIGS. 1a and 1b has a sleeve 101 contacting the inside wall 3 of the reaction tube and cooling ribs 102 running radial inward from the sleeve. These cooling ribs provide for an enhanced dissipation of heat to the cooled reaction tube wall 8. The insert 100 is made of a material with good heat, transfer properties in order to allow for the greatest possible heat dissipation. The high temperature region 7 is in this way additionally cooled, something that assists in bringing the high temperature region 7 to a standstill.

According to the embodiment 200 depicted in FIGS. 2a and 2b the insert has a solid cross-section with a central bore 201. The diameter of the bore 201, that is the through-flow cross section, is determined on the basis of the specified limit temperature in order to achieve that through-flow velocity that is necessary to stop the high temperature region 7. Any eventual maximum admissible pressure losses must be taken into account when designing the insert 200. To minimise the entry and exit pressure losses the bore 201 expands on both of its ends 202 conically or trumpet-like, preferably in the shape of a Venturi tube.

The embodiments 100, 200 according to the FIGS. 1a, 1b and 2a, 2b can for reasons of cost be made, as an example, of cast parts and simply slid into the reaction tube 2. By means of a longitudinally slotted design of the device (similar to a clamping sleeve) good contact to the inside wall 3 of the reaction tube can be achieved.

FIGS. 12a and 12b show a modification of the embodiment according to FIGS. 2a and 2b.

The embodiment or the device 1200 according to FIGS. 12a, 12b comprises a displacer 1201 that is formed cylindrically in the embodiment shown. With this embodiment 1200 as well the displacer 1201 narrows the through-flow cross-section of the reaction tube 2, but in this case the displacer 1201 is located centred in the reaction tube 2 and directs the gas flow G outwards onto the inner wall 3 of the reaction tube 2.

The displacer 1201 can be formed as a gas-tight solid cross-section made of a material with poor heat-conductivity, such as ceramics. But it can just as well be formed as a hollow body of metal with a thin wall.

The outer diameter of the displacer 1201 is smaller than the inner diameter of the reaction tube 2 by a specified degree so that in the condition where the device or the insert 1200 is installed in the reaction tube 2, there is an annular gap 1204 of specified size between the outside of the cylindrical circumferential wall 1203 of the displacer 1201 and the inner wall 3 of the reaction tube 2. The annular gap extends along the entire axial length of the displacer 1201 and around the entire circumference.

The through-flow cross-section is narrowed down by the annular gap 1204 to a specified size, thereby causing a corresponding increase in the through-flow velocity. The width of the annular gap 1204 is determined on the basis of the specified limit temperature in order to achieve the increased through-flow velocity that is required to stop the high temperature region 7. In that way the turbulence in the gas flow G is also increased and as a result of this the transfer of heat to the cooled reaction tube wall 8. In comparison with the embodiment shown in FIGS. 2a and 2b, there is the additional effect of a much enlarged heat transfer surface, the surface being formed directly by the cooled inner wall 3 of the reaction tube 2.

The displacer 1201 is supported by spacers 1205 on the inner wall 3 of the reaction tube 2. If the displacer 1201 is provided in the lower end portion of the reaction tube 2 then either one of its end surfaces 1202 bears directly on a catalyst holder 1206, as shown in FIG. 12a, or it is embedded in the filling 6 made up of catalyst particles 4. If the displacer 1201 is located in the upper end portion of a reaction tube 2 then it can rest directly on the catalyst filling 6 or, depending on the process to be run, be embedded in the catalyst filling 6.

In the examples shown the inserts 100, 200, 1200 border on the catalyst filling 4. They can additionally be embedded in inert material (not shown in the figures).

With the embodiments described below the high temperature region or hot spot 7 triggers action in the inventive devices or inserts 1 leading to extinction of the hot spot 7.

The embodiments of an inventive device 1, shown in FIGS. 3 through 7, have mechanically moveable parts with a trigger mechanism where after triggering the mechanically moveable parts close off the reaction tube 2 through gravity or elastic force.

Suppressing the gas flow G from passing through a reaction tube 2 is done by closing off the relevant reaction tube 2 by means of mechanically moved parts with the aid of gravity or one or more springs. The closing mechanism is triggered by heating up of the device 1. For that reason it is essential that the part of the device that triggers the closing action by heating up is embedded in the filling 6 while the room for movement of the moveable parts is free of particles. In this context, each effect can be used that is brought about by heating up such as the melting off of material, the shape memory properties of materials, the bimetal effect and/or expansion from heat.

The device 300 shown in FIG. 3 has a shut-off unit 301 and a shut-off seat 302 that in their initial state (i.e. until the limit temperature is achieved) are arranged at a specified distance to each other in the axial direction. This distance has been specified such that it allows for unobstructed through-flow of the reaction gas mixture G through the intermediate space 303 between the shut-off unit 301 and the shut-off seat 302.

The shut-off unit 301 has a truncated cone shaped or conical section 304 facing the shut-off seat 302 and whose outside surface forms a sealing surface 305, and a cone-shaped section 306 facing away from the shut-off seat 302 that allows for a passing by of the reaction gas mixture G as unobstructed as possible.

The shut-off seat is formed as a cylindrical ring 302 whose radial inner wall 307 is conical and forms a seat surface for the sealing surface 305 of the shut-off unit 301.

The seat surface 307 of the shut-off seat 302 and the sealing surface 305 of the shut-off unit 301 are formed such that they form, when contacting each other, a gas-tight seal.

The outside diameter of the shut-off seat 302 is only somewhat smaller than the inner diameter of the reaction tube 2. On the outer periphery of the shut-off seat 302 an annular groove 308 or equivalent circular seat is formed in which a sealing ring 309 is accommodated that is in gas-tight contact with both the groove bottom 301 or the seat as well as with the inner wall 3 of the reaction tube 2.

From the radial outer edge of the front surface 310 of the shut-off seat 302, facing away from the shut-off unit 301, there extends a cylindrical outer sleeve 311 whose outer surface contacts the inside reaction tube wall 3.

From the radial inner edge of this front surface 310 of the shut-off seat 302 there extends a perforated protective sleeve 312 concentrically into the outer sleeve 311. Between the protective sleeve 312 and the outer sleeve 311 there is a specified distance. This intermediate space is in the operating condition filled up to the front surface 310 of the shut-off seat 302, facing away from the shut-off unit 302, with catalyst particles 4 so that the shut-off seat 302 touches the end surface of the catalyst filling 4 and the perforated protective sleeve 312 is completely embedded in the catalyst filling 4. The inner space 313 of the protective sleeve 312 is completely free of filling particles. The perforation of the protective sleeve 312 is designed such that the reaction gas mixture G can flow through unobstructed but the penetration of filling particles 4 is prevented.

The perforated protective sleeve 312 has a first section 314 whose internal diameter corresponds to the diameter of the radial inner edge of said front surface 310 and which is fastened to this inner edge and there forms an entry orifice 315.

At the end of the first section 314 facing away from the shut-off seat 302 a second section 316 is connected whose diameter is smaller than the diameter of the first section 314. The length of the second section 316 is at least as large as the distance from shut-off unit 301 and shut-off seat 302 in axial direction before reaching the limit temperature, i.e. as large as the sliding path of the shut-off unit 301 towards the shut-off seat 302 when the limit temperature is reached.

The shut-off unit 301 is fastened immovably at one end of a guide rod 317 relative to the latter, the guide rod 317 running out of the free front surface of the conically shaped section 304. The guide rod 317 extends through a guide sleeve 318, that is attached centrically in the entry orifice 315 of the perforated protective sleeve 312, into the latter. Its second end is melted into a solder locking 319 that is fastened immovably relative to the protective sleeve 312 by means of a solder holder 320 in the first section 314 of the perforated protective sleeve 312 near its second section 316.

The composition of the solder 319 and thus its melting point is adapted to the reaction conditions, specifically to the temperatures of the heat transfer medium and the specified limit temperature.

In addition, the solder connector 319, which is to be melted off, can be provided with ribs in order to improve heat dissipation, or the solder 319 may partially be formed in the form of ribs.

A pretensioned spring 321 (in the example shown a helical spring) is fastened with one end to the solder holder 320 and with the other end to the guide rod 317 near the guide sleeve 318 at its side facing the solder locking 319.

In the non-triggered condition of the device 300, i.e. when the solder locking 319 has not melted, the reaction gas mixture G flows between the shut-off unit 301 and the shut-off seat 302, through the central orifice of the shut-off seat 302 into the entry orifice 315 of the perforated protective sleeve 312, passing by the protective sleeve 318 and the helical spring 321 as well as the solder locking 319, at first radially outwards through the perforated wall of the protective sleeve 312 and then again essentially evenly distributed across the entire filling cross-section along the reaction tube 2.

If a hot spot 7 (as shown in FIG. 3) approaches counter-current to the direction of flow of the reaction gas mixture G then the solder 319 melts at the specified limit temperature and in doing so releases the second end of the guide rod 317. With this, in turn, the pretensioned spring 321 can contract and in this way pull the guide rod 317 into the protective sleeve 312 and thus pull the shut-off unit 301 onto the shut-off seat 302. Since the space in which the spring 321 extends and the space into which the guide rod 317 shifts after the solder 319 has melted off are free of particles 4, an unobstructed movement of the spring 321 and the guide rod 317 is ensured.

In that context the remaining elastic force in the partially released condition of the spring 321 is adjusted such that a gas-tight seat of the sealing surface 305 of the shut-off unit 301 on the seat surface 307 of the shut-off seat 302 is ensured, even supported by the gas pressure applied on the shut-off unit 301. The through-flow cross-section of this reaction tube 2 is thus reduced to zero so that no more reaction gas mixture G flows through this reaction tube 2 and thus the hot spot 7 is extinguished.

The device 300 shown in FIG. 3 is designed to be installed on the gas entry sided end of the filling 6. Here this gas entry sided end can be both the upper as well as the lower end of a reaction tube 2.

If, as shown in FIG. 3, the device 300 is mounted at the upper end of the reaction tubes 2 then the spring 321 could also be dispensed with, since in that case the closing mechanism would function simply on the basis of gravity, i.e. the shut-off unit 301 would fall into the shut-off seat 302.

If the gas entry-side end is the lower end of the reaction tubes 2 then for this installation place the device 300 shown in FIG. 3 is rotated by 180° with the spring 321 then being necessary as the driving force for the shut-off unit 301. With this embodiment, the shut-off unit 301 should be made as light as possible in order to keep the necessary elastic force as low as possible and in order to achieve minimal delays when closing.

Advantageously with this embodiment 300 the device can be inserted in combination with a catalyst holder into the reaction tube 2 from below.

Filling of the reaction tubes 2 is extremely simple with this arrangement since the catalyst particles or inert particles 4, 5, filled into the reaction tube 2 from above, are distributed evenly around the protective sleeve 312 of the device without any further steps.

Essential in any case is that the solder locking 319 is embedded deep in the filling 6 and upon contact with the hot spot 7 quickly melts so that the closing mechanism closes or the hot spot 7 is extinguished before the hot spot 7 reaches the surface of the filling 6.

In this way only a respective affected reaction tube 2 of the tube bundle reactor is taken out of operation so that penetration of the high temperature region 7 into the gas inlet hood and a concomitant ignition of the explosive gas mixture G located there is prevented, something that in turn otherwise would have entailed shut down of the entire tube bundle reactor.

The device 400 shown in FIG. 4 corresponds in its functioning basically to the one 300 in FIG. 3. This device 400 too can be installed on the upper or the lower end of a reaction tube 2.

The difference lies in the fact that this device 400 is suitable for an arrangement on the gas exit-side end of the reaction tubes 2. The shut-off seat 402 is with this embodiment 400 arranged at a distance to the end surface of the filling 6 or to the entry orifice 415 of the perforated protective sleeve 412, respectively, on the side of the shut-off unit facing away from the spring 421, that is in FIG. 4 above the shut-off unit 401 so that the shut-off unit 401, after melting of the solder locking 419, is pressed by the reaction gas flow G into the shut-off seat 402.

The shut-off unit 401 is in its initial condition, that is when the solder locking 419 has not yet melted, arranged at a slight distance from the guide sleeve 418. In the embodiment 400 shown in FIG. 4 the spring 421 is precompressed in order to press the shut-off unit 401 away from the filling 6 or to press the guide rod 417 out of the perforated protective sleeve 412, respectively, when the solder locking 419 melts. One end of the spring 421 is again fastened to the holder 420 for the solder locking 419.. The other end of the spring 421 is fastened at a specified distance from the guide sleeve 418 on the guide rod 417. This distance is designed so that sufficient space is left to slide the shut-off unit 401 up to the shut-off seat 402.

The solder locking 419 is again fastened to the free second end of the guide rod 417 but could be fastened to any point on the section of the guide rod 417 that extends out from the spring 421. The guide rod 417 extends completely into the second section 416 of the protective sleeve 412 so that in the example shown in FIG. 4 the solder locking 419 is located on the closed end of that second section 416.

If the hot spot 7 reaches the solder locking 419 the latter melts and releases the guide rod 417. Thereupon the spring 421 presses the shut-off unit 401 upwards into the shut-off seat 402.

In the installation position shown in FIG. 4 a spring 421 is required as a driving force for the shut-off unit 401. If the device 400 is installed at the lower end of the reaction tubes 2 it is rotated by 180°. In that case, the shut-off unit 401 falls due to gravity into the shut-off seat 402. A spring 421 can then be dispensed with.

The embodiments 500, 600 of the inventive devices 1 shown in FIGS. 5a, 5b and 6 are designed for installation at the lower reaction tube end. Its closing mechanism functions due to gravity.

The device 500 shown in the FIGS. 5a and 5b is formed to be installed on the gas entry-side lower reaction tube end. It has a sleeve-shaped section 501 forming an inner elongated cavity 502 one end of which is closed off and the other end of which is left open. The open end of the cavity 502 or of the sleeve-shaped section 501, respectively, is provided with inside threads 503. A shut-off plug 504 with outer threads 505 is screwed into this open end so that the sleeve-shaped section 501 and the shut-off plug 504 together form an elongated cavity 502 closed on both ends.

The outer diameter of the sleeve-shaped section 501, here below referred to as the sleeve 501 for short, is smaller by a specified dimension than the inner diameter of the reaction tube 2 in order to allow for unimpeded through-flow of the reaction gas mixture G between the outer wall of the sleeve and the inner wall 3 of the reaction tube.

On the end of the sleeve-shaped section 501 facing away from the shut-off plug 504 an outer thickening 506 has been moulded onto the outer surface, the outer diameter of which is only somewhat smaller than the inner diameter of the reaction tube 2 in order to allow for sealing towards the inner wall 3 of the reaction tube.

The outer thickening 506 is formed from a conical and a cylindrical section. An annular seal 507 contacts on the one hand on this conical surface and the outer sleeve surfaces placed further back as well as on the other hand the inner wall 3 of the reaction tube 2 in order to form a gas-tight seal there.

The cavity 502 formed by the sleeve 501 and the shut-off plug 504 forms a through-flow channel for the reaction gas mixture G that can be closed off by means of a shut-off unit 508 that is designed in the example shown as a sphere.

On the inner surface of the shut-off plug 504 facing the cavity 502 a semi-spherical shaped recess 509 is formed in which the sphere 508 soldered on. The melting point of the solder 510 corresponds to the specified limit temperature.

At a specified distance from the shut-off plug 504 with the soldered-on sphere 508 the sleeve wall thickens inwardly into the cavity 502 to such a size that the reduced cavity diameter 511 is smaller by a specified degree than the diameter of the sphere 508. At the transition to the reduced cavity 511 a conical surface 512 is formed forming in turn a contact or resting surface for the sphere 508, when the solder 510 is melted.

Entry bores 513 (of which there are four in the example shown in FIG. 5b) open on the one hand into the broadened front surface 514 of the sleeve 501 facing away from the shut-off plug 504 and on the other hand into the cavity 502. They are semi-spherically distributed at a specified distance in circumferential direction over one-half of the front surface 514.

The entry bores 513 extend parallel to the longitudinal axis of the sleeve 501 completely through that inner thickening 515 and subsequently with half of its cross-section through the non-thickened sleeve wall 516 by which the entry bores 513 open into the cavity 502.

In the sleeve wall section 517 opposite the entry bores 513 in the vicinity of the outer thickening 506 and the annular seal 507, i.e. in the region of the inner thickening 515, an outlet orifice 518 is formed through which the reaction gas mixture G can flow into the ring space 519 between the outer wall of the sleeve and the inner wall 3 of the reaction tube. On the outer side of the outlet orifice 518 a protective screen 520 is attached that prevents penetration of filling particles 4.

In operating condition, i.e. installed in a vertical reaction tube 2 at the lower end thereof, the shut-off plug 504 with the soldered-on sphere 508 forms the upper end of the device 500 while the outer thickening 506 forms the lower end of the device 500, being supported by a holder 521. The shut-off plug 504 with the soldered-on sphere 508 is embedded in the catalyst filling 6 while the other end 514 of the device 500 forms the lower end of the catalyst filling 6 and therefore is not embedded.

The reaction gas mixture G flows from below into the entry bores 513 in which it flows upwards and enters at the top the cavity 502. In the cavity 502 the flow direction G is deflected downwards to the lower end of the sleeve. There it exits via the outlet orifice 518 and enters the ring space 519 between the sleeve 501 and the inner wall 3 of the reaction tube where again an upward deflection of the flow direction takes place.

If the hot spot 7 reaches the upper end of the device 500 (as shown in FIG. 5a) the solder locking 510 between the shut-off plug 504 and the sphere 508 melts, as the result of which the sphere 508 is released and falls downwards. This fall is additionally promoted by the direction of flow of the reaction gas mixture G. The sphere 508 falls into the conical seat 512 and in that way blocks entry into the lower reduced cavity 511. In this way the through-flow is blocked. Due to deflection of the flow the sphere 508 is pressed into its conical seat 512 and retained there.

As shown in FIG. 5a, an inventive device installed at the lower end of a reaction tube can simultaneously assume the function of a catalyst holder 521. In that case it could be the combination with a standard catalyst holder, or the holder can be directly integrated into the device. Additional designs can be produced with which several catalyst holders are combined together in one module in order to facilitate quicker mounting.

The device 600 shown in FIG. 6 is designed for installation at the lower end of a reaction tube on its gas exit-side. The functioning corresponds to the device 500 shown in FIGS. 5a and 5b. But the structure is basically simpler since the direction of fall of the sphere 608 and the direction of flow of the reaction gas mixture G through the reaction tube 2 are the same.

In this embodiment the device 600 has a sleeve 601 that is closed off at one end directly by means of a soldered-on sphere 608, the diameter of the sphere 608 being smaller than the inner diameter of the sleeve 601. With its other, open end the sleeve 601 rests on the top side 603 of a cylindrical ring 606, the top side 603 being broader than the wall of the sleeve 616.

The outer diameter of the sleeve 601 is smaller by a specified degree than the inner diameter of the reaction tube 2 in order to form a ring space 619 between the sleeve 601 and the reaction tube 2, the ring space 619 thus allowing for an unobstructed through-flow of the reaction gas mixture G. The inner diameter of the sleeve 601 corresponds to the inner diameter of the cylindrical ring 606 in the area of its top side 603, the top side 603 extending radially outwardly beyond the sleeve wall 616 and there forming a catalyst holder.

In the direction of the side facing away from the sleeve 601 the cylindrical ring 606 thickens both radially towards the inside as well as radially towards the outside with alternating cylindrical and conical sections, whereby it is sealed off on the outside towards the reaction tube 2 and forms on the inside a flow passage 604. On the radially inner side the conical surfaces 605 reduce the diameter of the flow passage 604 by a specified degree to a diameter that is smaller than the diameter of the sphere 608, and thus form a seat for the sphere 608. The radially outer conical surfaces 609 enlarge the outer diameter of the cylindrical ring 606 to an outer diameter that is only somewhat smaller than the inner diameter of the reaction tube 2. An annular seal 607 contacts there on one side the cylindrical ring 606 and on the other side the inner wall 3 of the reaction tube in order to seal off the intermediate space 619 between the cylindrical ring 606 and the inner wall 3 of the reaction tube.

In the state of installation in a reaction tube 2 the upper end of the device 600 is embedded in the catalyst filling 6 while its lower end forms the lower end of the catalyst filling 6.

The cylindrical ring 606 in this case bears on a catalyst holder 621 and can even be designed as one.

In the end section of the sleeve wall 616 resting on the cylindrical ring 606 passage orifices 618 are formed for the reaction gas mixture G through which the reaction gas mixture G gets from the outside to the inside 602 of the sleeve from where it flows further downwards through the flow passage 604 in the cylindrical ring 606. On the outside of the passage orifices 618 protective screens 620 are attached, e.g. in the form of a perforated sleeve, that prevent penetration of particles 4 from the filling 6.

In normal operations the reaction gas mixture G flows around the sphere 608 downwards into the ring space 619 between the sleeve wall and the inner wall 3 of the reaction tube. The reaction gas mixture G flows through the passage orifices 618 from the outside to the inside 602 of the sleeve and from there downwards through the flow passage 604 in the cylindrical ring 606.

If the hot spot 7 reaches the upper end (as shown in FIG. 6) the solder 610 melts. The sphere 608 is thereby released and falls, promoted by the direction of flow of the reaction gas mixture G, downwards into the conical seat 605 and in that way blocks through-flow.

FIG. 7 shows an inventive device 700 having an element 701 formed from a material with shape memory function. The composition of the material, preferably a metal, is adjusted such that it reassumes its original shape at the specified limit temperature. This embodiment 700 is in particular suitable for the gas entry-side ends of the reaction tube and can be installed both at the upper as well as at the lower end of the reaction tube.

The element 701 with shape memory function is enveloped by a perforated gas-permeable sleeve 702 having a closed end or a sleeve base 703, respectively, and an open end 704 out of which the element 701 with the shape memory function protrudes.

The sleeve 702 is embedded in the catalyst filling 6 in the state of being inserted into the reaction tube 2, the open end 704 of the sleeve opening into the end surface 705 of the catalyst filling. The embedding into the catalyst filling 6 occurs analogously to that of the device 300 described in FIG. 3.

The outer surface of the sleeve 702 has a specified distance to the inner wall 3 of the reaction tube in order to allow for an unobstructed flow of the reaction gas mixture G in the intermediate space 706 between the sleeve 702 and the inner wall 3 of the reaction tube.

The sleeve 702 is connected at its open end 704 (the upper end in FIG. 7) on the outside with a radially extending ring shaped disk 707, which in its installed condition is sealed 708 against the inner wall 3 of the reaction tube.

In the embodiment 700 shown, the element 701 with shape memory function is helically wound, is stretched into the plastical range and fastened at one end near the sleeve base 703. At the other end of the element 701 that protrudes from the open end 704 of the sleeve 702, a lid 709 is attached the outer diameter of which is larger than the inner diameter of the ring shaped disk 707. In normal operations, that is in non-triggered condition, the lid 709 has a specified distance to the ring shaped disk 707 in the longitudinal direction of the device 700 or the reaction tube 2, respectively, so that a specified through-flow section is left free or is available for the reaction gas mixture G. In normal operations the reaction gas mixture G passes the lid 709 and the ring shaped disk 707 and flows into the perforated sleeve 702 and subsequently radially through the perforation outwards into the catalyst filling 6. If a hot spot 7 moves in the reaction tube 2 towards the sleeve base 703 (in FIG. 7 upwards) it increasingly also heats up the element 701 made of metal with shape memory function as it brushes along the perforated sleeve 702. The element 701 contracts when the limit temperature is reached as the result of which the lid 709 located on its free end is pulled onto the ring shaped disk 707 and in that way the through-flow section is blocked.

Embodiments, in which a closure is used having a material with the capability of changing its shape (such as a metal with shape memory function or a bimetal) or having a combination of solder melting down in together with a closing spring, can be replaced by each other.

FIG. 8 shows an embodiment 800 of an inventive device 1 where when the limit region is reached a molten material 801 flows out of the high temperature region 7 into a cooler space and there solidifies again. The embodiment 800 shown in FIG. 8 is suitable for installation in a lower gas entry-side end of a reaction tube.

It has a gas-tight sleeve 802, which comprises a closed and an open end 803, 804 and at a distance envelops a hollow cylinder 805 concentrically that likewise has a closed and an open end 806, 807, the open end 807 of the hollow cylinder 805 lying close to the open end 804 of the gas-tight sleeve 802. The outer diameter of the sleeve 802 is smaller by a specified degree than the inner diameter of the reaction tube 2.

The hollow cylinder 805 forms a flow channel for the reaction gas mixture G, its open end 807 being the entry orifice.

Close to the other, closed end 806 of the flow channel or the hollow cylinder 805, respectively, passage orifices 808 are formed in its wall through which the reaction gas mixture G can flow into the ring space 809 formed between the inner surface of the gas-tight sleeve 802 and the outer surface of the flow channel 805.

The sleeve 802 rests on a catalyst holder 810 and the flow channel 805 with its entry orifice 807 (in FIG. 8 the lower end) opens through the catalyst holder 810 into the area 811 of the lower reaction tube end, said area being free of particles.

On the catalyst holder 810 around the hollow cylinder 805 a ring 812 made of a carrier material is provided, the melting point of which lies significantly above the limit temperature or the melting point of the material 801, being capable of melting off as a liquid.

This ring 812 made of carrier material serves as a supporting area for the gas-tight sleeve 802 and extends in the intermediate space 813 between the outer surface of the hollow cylinder 805 and the inner wall 3 of the reaction tube. The outer ring space 814 between the gas-tight sleeve 802 and the inner wall 3 of the reaction tube is filled with catalyst material when the device 800 is installed.

Close to the end of the gas-tight sleeve 802 that rests on the catalyst holder 810 or the ring 812 made of carrier material, respectively, the wall of the gas-tight sleeve 802 has outlet orifices 815 for the reaction gas mixture G, through which the reaction gas mixture G exits from the device 800 and enters into the catalyst filling 6.

On the closed end 806 of the hollow cylinder 805 facing away from the entry orifice 807 a material or solder 801, respectively, is provided that fills up the space up to the closed end 803 of the sleeve 802 and melts into a liquid at the specified limit temperature. Between the closed end surface 806 of the hollow cylinder 805 and the gas-tight sleeve 802 in a radial direction a ring gap 816 of specified size is formed through which the molten material 801 flows downwards.

In normal operations the reaction gas mixture G flows through the entry orifice 807 upwards into the hollow cylinder 805 and flows out through the latter's passage orifices 808 and into the ring space 809 between the hollow cylinder 805 and the gas-tight sleeve. In the ring space 809 the reaction gas mixture G flows downwards and exits through the outlet orifices 815 of the gas-tight sleeve 802 and flows into the ring space 814 between the latter 802 and the inner wall 3 of the reaction tube where it again flows upwards in the reaction tube 2. In this modification the reaction gas G is led with a deflection of flow through the device 800, similar to a siphon.

If a hot spot 7 approaches the embedded end 803 of the device 800 (in FIG. 8 from above) then the solder 801 located there melts. The liquid solder 801 flows into the area located lower and facing away from the hot spot, i.e. into the ring shaped trough-like region like at the lower end of the device 800 formed by the sleeve 802, the hollow cylinder 805 and the carrier material 812 and is collected there. In the trough the solder 801 solidifies by dissipation of heat to the wall 8 of the reaction tube and to the reaction gas mixture G entering into the hollow cylinder 805, optionally with the inclusion of a porous carrier material 812. The solidifying or solidified solder 801, respectively, closes off the flow section.

FIGS. 9a and 9b show two embodiments 900a, 900b of an inventive device 1 where when the limit temperature is reached a material 901 melts off viscously and in the longitudinal direction of the reaction tube 2 essentially remains in place, plugging off at that place downstream pores and in that way blocking the flow passage. The devices 900a, 900b shown in FIGS. 9a and 9b can be installed both in the upper end region as well as in the lower end region of a reaction tube 2 and both on the gas entry-side end as well as the gas exit-side end of the reaction tube.

Instead of a material 901 that melts off viscously a material can also be used that swells up or foams up when the limit temperature is reached and that under such conditions plugs off and closes off the flow channels.

The embodiment 900a shown in FIG. 9a is designed for a direction of flow of the reaction gas mixture G in the reaction tube 2 downwards from above. The device 900a has a holder 902 lying on the catalyst filling 6 and a porous carrier layer 903 which in turn lies on the holder 902. The porous carrier layer can be made of a metal filling, a sintered material or a metal tissue similar to a filter cake. On that porous carrier layer 903 a layer of very viscously melting material 901 such as a viscously melting solder is applied. In the embodiment according to FIG. 9a there is, above the device 900a, another filling of inert material 5.

If the hot spot 7 approaches the device 900a from above or below (as shown in FIG. 9a) the solder 901 melts when the limit temperature is reached, and the solder is urged against the porous carrier layer 903 by the reaction gas mixture flowing through and closes the pores in the porous carrier layer and thus closes off the flow passage.

With the embodiment 900b shown in FIG. 9b the reaction gas mixture G flows upwards from below. Here above the layer of very viscously melting material 901 an additional porous carrier layer 904 is provided so that the material 901 melted by the hot spot 7 is not carried out with the reaction gas mixture G but may close off the pores in this porous carrier layer 904 and in that way closes off the flow passage. This is an additional safety measure despite the property of the molten material 901 that is highly viscous in any case.

FIG. 10 shows an embodiment 1000 with which the material 1001 that melts off viscously is formed as a porous filling between two concentric cylindrical sleeves 1002, 1003. This embodiment 1000 is suitable for installation in the gas entry-side end of a reaction tube 2.

The inner sleeve 1002 has two open ends 1004, 1005 while the outer sleeve 1003 has one open end 1006 and one end closed off by a base 1007.

Between the outer wall of the outer sleeve 1003 and the inner wall 3 of the reaction tube a ring space 1008 is formed that forms a specified through-flow section.

The inner 1002 of the two concentric sleeves is surrounded on one end 1004 by a cylindrical ring 1009 that has on its outer surface successively a cylindrical, conical and once again cylindrical section and that is sealed against the inner wall 3 of the reaction tube by means of an annular seal 1010. Through the cylindrical ring 1009 there runs a centred cylindrical bore 1011 through which the one end 1004 of the inner concentric sleeve 1002 extends, the latter being fastened in the cylindrical bore 1011.

The other end 1005 of the inner concentric sleeve 1002 ends at a specified distance from the base 1007 of the outer cylindrical sleeve 1003, whereby the distance to the base 1007 is spanned by a perforated sleeve 1012. This perforated sleeve 1012 prevents the porous filling 1001 between the two sleeves 1002, 1003 from penetrating into the lower area of the inner sleeve 1002.

The open end 1006 of the outer concentric sleeve 1003 ends at a specified distance from the cylindrical ring 1009 so that unobstructed flow deflection of the reaction gas mixture G is possible from the intermediate space between the two concentric sleeves 1002, 1003 into the ring space 1008 between the outer sleeve 1003 and the inner wall 3 of the reaction tube.

The two concentric sleeves 1002, 1003 extend into the catalyst filling 6 when installed so that the material 1001, that melts off viscously and is located between the two sleeves, is embedded in the catalyst filling 6. On the side of the cylindrical ring 1009 facing away from the concentric sleeves 1002, 1003 an additional filling of inert material 5 can also be located.

If the hot spot 7 approaches the viscously melting material 1001 embedded in the catalyst material 4 the material 1001 melts when the specified limit temperature is reached. The gas flow carries the molten material 1001 away from the hot spot 7 in the direction towards the cylindrical ring 1009 (in the embodiment shown in FIG. 10 into the upper part of the filling 6) where it resolidifies and plugs off the flow pathes. In this way, it reliably prevents the molten mass 1001 form being carried off by the gas flow.

FIG. 10 shows the installation in the upper area of a reaction tube 2.

For installation in the lower area of a reaction tube 2 this device 1000 is rotated by 180° so that the cylindrical ring 1009 with the entry orifice 1004 of the inner concentric sleeve 1002 again lies on the gas entry side of the device 1000.

FIGS. 11a and 11b show an embodiment 1100 of an inventive device 1 where, when the limit temperature is reached, an element or material 1101 softens into viscous form and is squeezed or compressed in the longitudinal direction of the reaction tube 2 and in that way closes off the through-flow cross section. This embodiment 1100 is suitable for both the gas inlet end as well as the gas outlet end of a reaction tube and can be installed both on the upper as well as on the lower end of a reaction tube.

An example of a suitable material for the element 1101 would be glass. Glass is a highly viscous melting material that is also referred to as a frozen liquid since it in transitioning from the solid state into the liquid state hardly changes its structure. With increasing temperature glass softens and becomes viscous. However, in doing so it changes its shape only by any greater exertion of force.

The element 1101 is formed to be gas permeable. In the embodiment shown it is a monolithic element with flow channels 1102 that can run parallel to the longitudinal direction of the reaction tube 2. But the element 1101 can also be made of (not shown) glass rods and glass tubes arranged in parallel to each other. In addition, it is also feasible that the element 1101 can be made of irregularly arranged filler material or of ordered filler packing.

The element 1101 can thus be made of a single body or an arrangement of several loose or connected bodies. The structure of the element 1101 is only subject to a few limitations. The latter consist of the element being sufficiently gas permeable, not having any greater pressure loss and in that self-locking cannot occur. In this context, self-locking is taken to mean a condition where single sections of the element 1101, due to the pressure force exerted in the longitudinal direction of the reaction tube 2, wedge against each other and against the inside wall of the device 1100 or of the reaction tube 2 such that the pressure force is not effective any more on the sections of the element that lie behind the wedged-up sections. This effect occurs, for instance, with loose inordinate or randomly distributed pellet fillings. Self-locking can be avoided by sintering the filling bodies on their contact surfaces or by means of a suitably ordered packing of the filler bodies.

If the element 1101 is made of a number of glass spheres then the ratio of the diameter of the glass spheres to the inner diameter of the device 1100 or the inner diameter of the reaction tube 2 preferably lies in a range from 10% to 46%, more preferably from 16% to 33% and most preferably from 20% to 24%. In that way in proper operations an adequate gas permeability is ensured while when the limit temperature is reached the deformation effort is still sufficiently low for a reliable closing off of the through-flow cross section. The same conditions apply if instead of glass spheres glass rods or glass tubes are used. In that case the outer diameter of the glass rods or glass tubes replaces the diameter of the sphere in the previously cited ratios.

The ratio of the length of the element 1101 in the longitudinal direction of the reaction tube 2 to the inner diameter of the device 1100 or the reaction tube 2 lies preferably in a range from 20% to 1000%, more preferably from 50% to 400% and most preferably from 60% to 150%.

The element 1101 is set under pressure by a biasing device 1103. In the embodiment shown this biasing device is formed as a pressure spring 1103 in contact with the element 1101 in the longitudinal direction of the reaction tube 2. The material of the pressure spring 1103 is selected for having sufficient longtime or creep strength with respect to the prevalent operating temperature. For even transfer of force from the pressure spring 1103 to the element 1101, a perforated disk 1104 is provided between the element 1101 and the pressure spring 1103.

The biasing device could also be formed as a tension device encompassing the element 1101 or extending through the element 1101, for example in the form of an outer net or a central strap, being pretensioned.

The element 1101 is located together with the disk 1104 and the pressure spring 1103 in a sleeve 1105 with perforated end plates 1106, 1107. In a condition where the device 1100 is installed in a reaction tube 2 the element 1101 is located on the side facing the catalyst filling 4. Depending on the tolerances of the sleeve 1105 and the inner diameter of the reaction tube 2, the outer diameter of the sleeve 1105 is given a tolerance such that the gap between the reaction tube 2 and the device 1100 allows for flowing of the viscously softening material thereinto.

The sleeve 1105 can (as FIG. 11a shows) be in one piece or formed from several parts. In the embodiment shown an end plate 1107 completely covers over the front side of the element 1101 facing the catalyst filling 4. By contrast, the end plate 1107 on the side of the pressure spring 1103 is ring shaped and only made large enough so that the pressure spring 1103 is retained in the sleeve 1105. In the region of the periphery of the element 1101 the sleeve 1105 has orifices 1108 distributed on its periphery and through which softened glass can flow or be pressed up to the inner wall of the reaction tube 2 so that the device 1100, is then sealed off against the inner wall of the reaction tube 2.

If a high temperature region 7 reaches the element 1101, with increasing temperature it softens and is squeezed together by the force of the pressure spring 1103 as well as by the flow pressure. In that way, the flow channels 1102 in the element 1101 are deformed and squeezed together until they are ultimately blocked or plugged off and the element 1101 loses its permeability for gas. In addition, the material of the element 1101 plugs off the passages of the perforated end plate 1106 on the front side of the element 1101. Through the orifices 1108 in the periphery of the sleeve 1105 the softened material flows up to the inner wall of the reaction tube 2 and, as already mentioned, seals off the device 1100 against that inner wall.

In order for the inventive devices 1 to be able to have optimum effect in their function (regardless of the specific embodiment) they must have a completely gas-tight sealing against the inner wall 3 of the reaction tube. According to the invention, this is achieved, as explained above, for instance by a ring groove placed on the circumference of the device or by another equivalent circumferential seat in which a ring shaped seal is located or, with some embodiments, by the material itself that melts off or ignites and fills up the space between the device and the inner wall of the reaction tube.

With some embodiments the devices may be completely or at least partially embedded in an inert filling. This can be achieved by having the mounting of device or (depending on the embodiment) of only some of its parts accomplished prior to or during filling of the reaction tube with the particle filling or by subsequently inserting the devices into a correspondingly prepared filling. Important in any case is close contact of the device with the particle filling since in that way fast reaction of the devices is achieved.

The operation and effectiveness of the inventive devices 1 can be enhanced by having at least two single devices, which are not necessarily formed according to the same embodiment, combined with each other.

The inventive measures are particularly suited for carrying out partial oxidation reactions, in particular for manufacturing maleic anhydride, phthalic anhydride, (meth)acrolein, (meth)acrylic acid, methyl-(meth)acrylate and acrylonitrile as well as ethanoic acid.

What is claimed is:

1. In a method for operating a tube bundle reactor for exothermic gas phase reactions having a tube bundle with catalyst-filled reaction tubes, wherein the one ends of the reaction tubes are spanned by a gas inlet hood and the other ends are spanned by a gas outlet hood and wherein around the outside of the reaction tubes a heat transfer medium flows to carry off reaction heat, comprising of the following steps: introducing an explosive gas mixture into the reaction tubes via the gas inlet hood and, after reaction, receiving and removing the possibly still explosive gas mixture from the reaction tubes via the gas outlet hood, wherein a high temperature region forms within each reaction tube, the improvement comprising the following steps:
specifying a limit temperature in the reaction tubes that lies above a maximum temperature that occurs in the high temperature region of the reaction tubes during normal operation of the tube bundle reactor, the limit temperature being equal at most to the ignition temperature of the explosive gas mixture (G); and
stopping a non-operating high temperature region that forms in the reaction tubes, and whose maximum temperature is at least equal to the limit temperature and that migrates in the respective reaction tube in the longitudinal direction thereof, while the high temperature region is still in the reaction tube, so that the high temperature region is prevented from advancing into either the gas inlet hood or the gas outlet hood.

2. Method as claimed in claim 1, wherein for stopping, migration of the high temperature region is brought to a standstill.

3. Method as claimed in claim 2, further comprising the step of increasing the dissipation of reaction heat at the ends of the catalyst filling.

4. Method as claimed in claim 2, wherein the gas flow velocity at the gas inlet side end of the catalyst filling is increased locally in order to bring migration of the high temperature region counter-current to the direction of gas flow to a standstill.

5. Method as claimed in claim 2, wherein the cooling effect is increased by the inflowing gas (G) at the gas inlet side end of the catalyst filling in order to bring migration of the high temperature region counter-current to the direction of gas flow to a standstill.

6. Method as claimed in claim 1, wherein for stopping, the high temperature region is extinguished.

7. Method as claimed in claim 6, wherein the flowing of gas through the respective reaction tube is interrupted.

8. Method as claimed in claim 6, wherein the reaction conditions in the respective reaction tube are changed.

9. Method as claimed in claim 8, comprising the step of providing at least one of a liquid and solid in the reaction tubes which, when reaching the limit temperature, at least one of evaporates, inerts and cools the gas flow.

10. A device for use in a tube bundle reactor for exothermic gas reactions, the tube bundle reactor having a tube bundle with catalyst filled reaction tubes, and wherein a heat transfer medium flows around the outside of the reaction tubes, the device having external dimensions designed for insertion in a reaction tube and having means that form a through-flow section that has a specified size when a specified limit temperature in the reaction tube is reached, said limit temperature lying above a maximum temperature that occurs in the high temperature region of the reaction tubes during normal operation of the tube bundle reactor, the limit temperature being equal at most to the ignition temperature of the explosive gas mixture (G), said device stopping a non-operating high temperature region in the reaction tubes, and whose maximum temperature is at least equal to the limit temperature and that migrates in the respective reaction tube in the longitudinal direction thereof, while the temperature region is still in the reaction tube, so that the high temperature region is prevented from advancing into either the gas inlet hood or the gas outlet hood.

11. Device as claimed in claim 10, comprising ribs that extend radially inwardly.

12. Device as claimed in claim 10, having a solid cross-section with a central longitudinal bore that widens radially in its end sections (202).

13. Device as claimed in claim 10, formed from a material which transfers heat well.

14. Device as claimed in claim 10, having an impenetrable displacer with an outer circumferential wall running, when inserted in a reaction tube, at a specified distance along the inner wall of the reaction tube, the displacer having poor heat-conductive properties in the longitudinal direction of the reaction tube.

15. Device as claimed in claim 10, wherein the size of the through-flow section is reducible to zero when the limit temperature is reached.

16. Device as claimed in claim 15, comprising at least one part made of a material that changes at least one of its shape and strength at the specified limit temperature and in that way effects an interruption of gas flow through the reaction tube.

17. Device as claimed in claim 16, wherein the part itself closes off a gas flow section in the reaction tube when the limit temperature is reached.

18. Device as claimed in claim 16, wherein the part triggers a close-off mechanism when the limit temperature is reached.

19. Device as claimed in claim 16, wherein the material is a bimetal.

20. Device as claimed in claim 17, wherein the material melts when reaching the limit temperature and plugs a gas flow section in the reaction tube.

21. Device as claimed in claim 20, wherein the material melts viscously and essentially remains where it is in the longitudinal direction of the reaction tube.

22. Device as claimed in claim 20, wherein the material melts as a liquid and flows out of the high temperature region into a cooler region and there solidifies again.

23. Device as claimed in claim 16, wherein the material has shape memory properties.

24. Device as claimed in claim 16, wherein the material expands.

25. Device as claimed in claim 24, wherein the material changes its shape by at least one of swelling and foaming and in that way plugs a gas flow section in the reaction tube.

26. Device as claimed in claim 18, wherein a biasing device exerts pressure on the part in the longitudinal direction of the reaction tube and wherein the part is made of a material that, when the limit temperature is reached, softens into viscous form and deforms due to prestress.

27. Device as claimed in claim 26, wherein the part substantially fills up the reaction tube laterally to its longitudinal direction and is permeable to gas.

28. Device as claimed in claim 26, wherein the part is made of glass.

29. Device as claimed in claim 26, wherein the biasing device is a spring.

30. Device as claimed in claim 10, wherein the device also serves as a catalyst holder.

31. (canceled)

32. Reaction tube for a tube bundle reactor for exothermic gas phase reactions, comprising a device as claimed in claim 10.

33. Reaction tube as claimed in claim 32, comprising a filling of catalyst particles, and wherein at least the parts of the device reacting to heat are embedded in the filling and the spaces for the movement of the moveable parts are free of catalyst particles.

34. Reaction tube for a tube bundle reactor for exothermic gas phase reactions, the tube bundle reactor having a tube bundle with catalyst-filled reaction tubes, wherein one end of the reaction tube bundle is spanned by a gas inlet hood and an opposite end is spanned by a gas outlet hood, and wherein a heat transfer medium flows around the outside of the reaction tubes to carry off reaction heat, the reaction tubes comprising a filling containing at least one of a liquid and solid that, upon reaching the limit temperature, at least one of evaporates, inerts and cools the gas flow.

35. Tube bundle reactor for exothermic gas phase reactions, wherein the tube bundle comprises reaction tubes as claimed in claim 32.

36. Use of a tube bundle reactor as claimed in claim 35, for manufacturing a composition of matter selected from the group consisting of maleic anhydride, phthalic anhydride, (meth)acrolein, (meth)acrylic acid, methyl-(meth)acrylate, acrylonitrile and ethanoic acid.
